(19) United States
(12) Patent Application Publication
(10) Pub. No.: US 2013/0223065 A1
(43) Pub. Date: Aug. 29, 2013

(54) STREET LAMP

(71) Applicants: KUAN-HONG HSIEH, Miaoli (TW); TE-SHENG CHEN, Miaoli (TW); WEN-HSIANG LU, Miaoli (TW); BO-YONG YANG, Shanghai (CN); ZHEN-RONG PENG, Shanghai (CN); YU ZHANG, Shanghai (CN)

(72) Inventors: KUAN-HONG HSIEH, Miaoli (TW); TE-SHENG CHEN, Miaoli (TW); WEN-HSIANG LU, Miaoli (TW); BO-YONG YANG, Shanghai (CN); ZHEN-RONG PENG, Shanghai (CN); YU ZHANG, Shanghai (CN)

(21) Appl. No.: 13/740,234

(22) Filed: Jan. 13, 2013

(30) Foreign Application Priority Data
Feb. 24, 2012 (CN) 201220062273.5

(51) Int. Cl. F21S 8/08

(52) U.S. Cl. CPC F21S 8/085
USPC 362/235; 362/362; 362/249.02

(57) ABSTRACT

A street lamp includes a lamp post and a lamp housing mounted on a distal end of the lamp post. An alternating current cable is received in the lamp post. A light source is received in the lamp housing. A power supplying device is electrically connected to the light source via a connecting cable. A connection device includes an Edison screw socket and an Edison male screw plug being detachably and threadedly engaged in the Edison screw socket. The Edison screw socket is electrically coupled to the alternating current cable, and the Edison male screw plug is electrically and mechanically coupled to the power supplying device. The power supplying device is configured for converting an alternating current into direct current and supplying the direct current to the light source.

### BACKGROUND

1. Technical Field

The present disclosure relates to a street lamp.

2. Description of Related Art

Power supplying device having built-in existing lamps with compact structure tends to have a short life. Because of the compact structure of the existing lamp, the power supplying device must be positioned close to the light source of the lamp, and the power supplying device suffers over-heating from the light source. When the power supplying device is applied to the lamp with LED light sources, such as LED street lamps, the heat generated by the LED light sources will increase the replacement or repair frequency of the power supplying device, which increase cost. Furthermore, the disassembly and installation of the power supplying device are very troublesome.

Therefore, a street lamp to resolve the problems mentioned above is needed.

### BRIEF DESCRIPTION OF THE DRAWINGS

Many aspects of the embodiments can be better understood with reference to the following drawings. The components in the drawings are not necessarily drawn to scale, the emphasis instead placed upon clearly illustrating the principles of the present disclosure. Moreover, in the drawings, like reference numerals designate corresponding parts throughout the several views.

FIG. 1 is an exploded view of a street lamp according to a first embodiment.

FIG. 2 is another exploded view of the street lamp of FIG. 1 according to a second embodiment.

### DETAILED DESCRIPTION

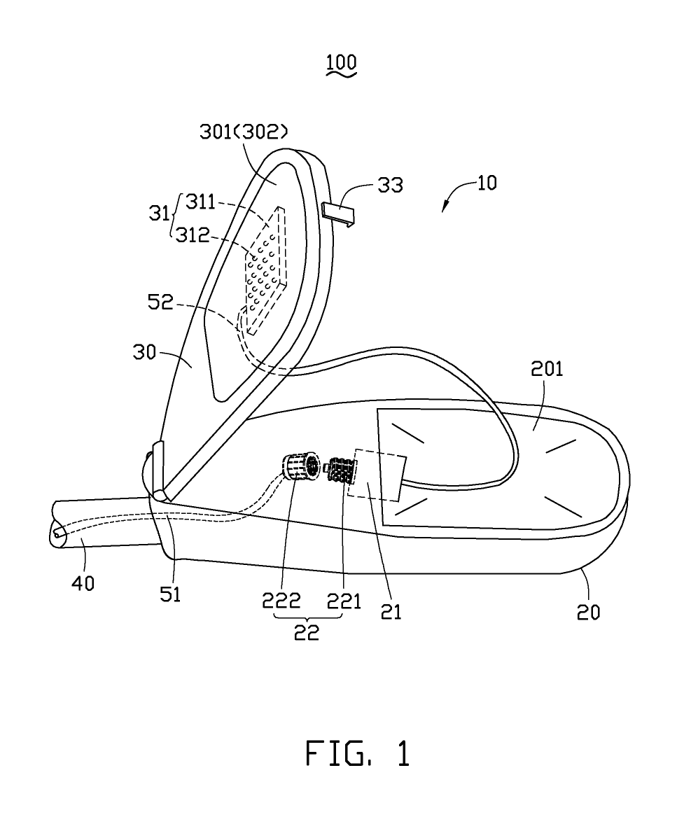

Referring to FIG. 1, a street lamp 100 includes a lamp post 40 and a lamp housing 10 mounting on a distal end of the lamp post 40. In the embodiment, the street lamp 100 is an LED street lamp.

An alternating current cable 51 is received in the lamp post 40, and the alternating current cable 51 is connected to an external power source (not shown).

A light source 31 is received in the lamp housing 10. In the embodiment, the light source 31 includes a circuit board 311 and a number of LED emitters 312 mounted on the circuit board 311.

A power supplying device 21 is electrically connected to the light source 31 via a connecting cable 52, and the power supplying device 21 is configured for converting an alternate current into direct current and supplying the direct current to the light source 31, to drive the LED emitters 312 to emit light beams. In the embodiment, the light source 31 is positioned in the lamp housing 10 away from the lamp post 40, and the power supplying device 21 is received in the lamp housing 10 close to the lamp post 40, so as to space apart from the light source 31, and the power supplying device 21 can thus be protected from the heat of the light source 31, which will effectively prolong the service life of the power supplying device 21. In an alternative embodiment, the power supplying device 21 is received in the lamp post 40.

A connection device 22 is received in the lamp housing 10. In an alternative embodiment, the connection device 22 is received in the lamp post 40. The connection device 22 is configured for connecting the power supplying device 21 to the external power source. In the embodiment, the connection device 22 includes an Edison screw socket 222 and an Edison male screw plug 221 being detachably and threadedly engaged in the Edison screw socket 222. The Edison screw socket 222 is electrically coupled to the alternating current cable 51, and the Edison male screw plug 221 is electrically and mechanically coupled to the power supplying device 21. In the embodiment, the Edison screw socket 222 is selected from a standard E27 socket and a standard E40 socket, and the Edison male screw plug 221 is correspondingly selected from a standard E27 plug and a standard E40 plug.

In the embodiment, the lamp housing 10 includes a shell 20 and a cover 30 attached to the shell 20. In the embodiment, the cover 30 is pivotally attached to the shell 20, in order to enable the cover 30 to be opened or closed relative to the shell 20. A number of hooks 33 are protruded from the edge of one of the cover 30 and the shell 20, which are configured for engaging with the edge of the other of the cover 30 and the shell 20, to fasten the cover 30 and the shell 20 together.

In the embodiment, the shell 20 defines a recess 201 at one end thereof away from the lamp post 40 and facing the cover 30, and the light source 31 is received in the recess 201.

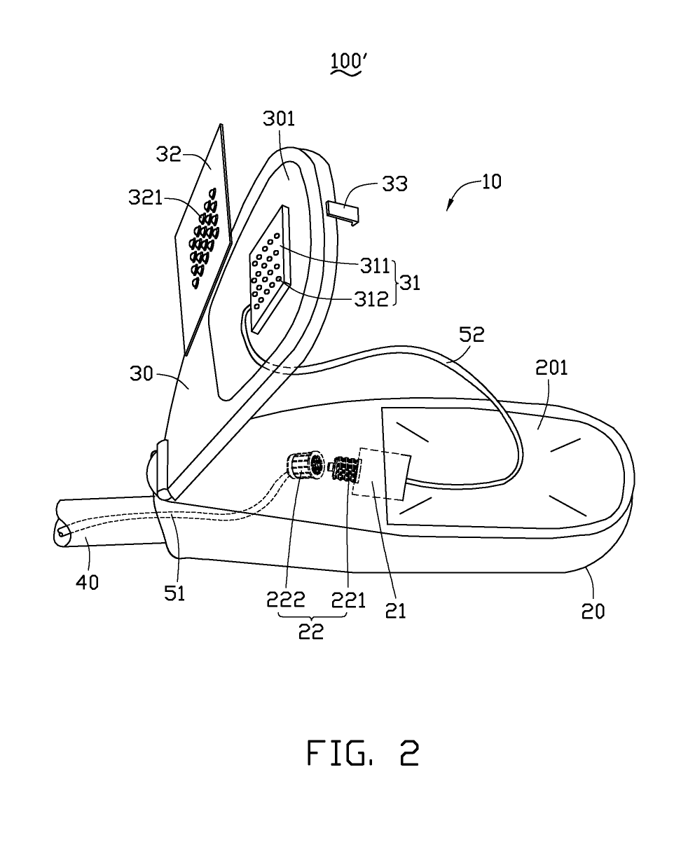

The cover 30 defines an opening 301 corresponding to the recess 201 of the shell 20. In the embodiment, a transparent protecting plate 302 is arranged on the cover 30 corresponding to the opening 301 for covering the light source 31. In other embodiment, referring to FIG. 2, a number of lens portions 321 are formed on the protecting plate 32, and the lens portions 321 are aligned with the respective LED emitter 312. The lens portions 321 are configured for adjusting optical properties of the light beams emitted by the LED emitters 312, so as to adjust the illumination angle of the light source 31. In the other embodiment, the surface of each lens portion 321 is covered by a coating film, which is configured for adjusting a color temperature of the light beams emitted by the LED emitters 312. The surface of each lens portion 321 can obtain the standard color temperature of existing high-pressure sodium lamp, which allows the street lamp 100 to substitute the existing sodium lamp.

Moreover, it is to be understood that the disclosure may be embodied in other forms without departing from the spirit thereof. Thus, the present examples and embodiments are to be considered in all respects as illustrative and not restrictive, and the disclosure is not to be limited to the details given herein.

What is claimed is:

1. A street lamp comprising:
a lamp post;
a lamp housing mounted on a distal end of the lamp post;
an alternating current cable received in the lamp post;
a light source received in the lamp housing;
a power supplying device electrically connected to the light source via a connecting cable; and
a connection device comprising an Edison screw socket and an Edison male screw plug being detachably and threadedly engaged in the Edison screw socket, the Edison screw socket electrically coupled to the alternating current cable, and the Edison male screw plug electrically and mechanically coupled to the power supplying device;
wherein the power supplying device is configured for converting an alternating current into direct current and supplying the direct current to the light source.

2. The street lamp of claim 1, wherein the Edison screw socket is a standard E27 socket or a standard E40 socket, and the Edison male screw plug is correspondingly a standard E27 plug or a standard E40 plug.

3. The street lamp of claim 1, wherein the lamp housing comprising a shell and a cover attached to the shell.

4. The street lamp of claim 3, wherein the cover is pivotally attached to the shell.

5. The street lamp of claim 4, wherein the shell defines a recess, and the light source is received in the recess.

6. The street lamp of claim 5, wherein the shell defines an opening corresponding to the recess of the shell, and the street lamp further comprises a transparent protecting plate arranged on the cover corresponding to the opening for covering the light source.

7. The street lamp of claim 6, wherein the light source comprises a circuit board and a plurality of LED emitters mounted on the circuit board.

8. The street lamp of claim 7, further comprising a plurality of lens portions formed on the protecting plate, and the lens portions are aligned with the respective LED emitters.

9. The street lamp of claim 8, wherein the surface of each lens portion is covered by a coating film, which is configured for adjusting a color temperature of the light beams emitted by the light source.

10. The street lamp of claim 1, wherein the power supplying device is received in the lamp housing.

11. The street lamp of claim 1, wherein the power supplying device is received in the lamp post.

12. The street lamp of claim 1, wherein the connection device is received in the lamp housing.

13. The street lamp of claim 1, wherein the connection device is received in the lamp post.
